(19) United States
(12) Patent Application Publication
(10) Pub. No.: US 2026/0208508 A1
(43) Pub. Date: Jul. 23, 2026

(54) SYSTEM AND METHOD USING UV ILLUMINATION FOR MISSING INK JET DETECTION

(71) Applicant: XEROX CORPORATION, NORWALK, CT (US)

(72) Inventors: Peter M. GULVIN, Webster, NY (US); Varun SAMBHY, Pittsford, NY (US); Seemit PRAHARAJ, Webster, NY (US); Jason M. LeFEVRE, Penfield, NY (US); Christine A. STEURRYS, Williamson, NY (US); Anthony S. CONDELLO, Webster, NY (US); Mark C. PETROPOULOS, Webster, NY (US); Douglas K. HERRMANN, Webster, NY (US); Nicholas David STUCCHI, Rochester, NY (US)

(73) Assignee: XEROX CORPORATION, NORWALK, CT (US)

(21) Appl. No.: 19/033,888

(22) Filed: Jan. 22, 2025

(51) Int. Cl. B41J 11/00; B41J 2/21; B41M 5/00

(52) U.S. Cl. CPC B41J 11/009; B41J 2/2114; B41J 11/0015; B41J 11/0095; B41M 5/0017

(57) ABSTRACT

A system and detection method for detecting missing primer jets in an inkjet printer is disclosed. The system includes a media path configured to transport paper through an inkjet printer, a print head having a plurality of primer jets configured to apply a primer solution to the paper when the paper is in proximity to the print head, an ultraviolet light source in proximity to the media path, an image sensor adjacent to the ultraviolet light source, and a controller configured to illuminate the paper with ultraviolet light from the ultraviolet light source during a detection cycle, and where the image sensor is configured to detect changes in reflectance of the paper caused by a presence or absence of primer on a surface of the paper. Implementations of the system may include a white light source.

### TECHNICAL FIELD

The present teachings relate generally to aqueous ink jet printing systems and, more particularly, to diagnostic methods and apparatus for pre-treatment applications.

### BACKGROUND

Digital aqueous ink jet (AIJ) printing is an area of growth for several production class printing systems. Printers or consumers of printed materials making or considering a transition from a dry powder (electrophotographic) printing system to an aqueous ink jet printing system or printing press require the maintenance of existing image quality (IQ) and print permanence and durability characteristics while reducing run cost per kiloprint (kp). Exemplary printing systems using the aqueous ink jet printing methods have significantly improved print image quality matching or exceeding current electrophotographic printing methods.

The image quality of aqueous ink images printed onto various types of media varies according to the type of media being printed. Image quality is typically exemplary when the aqueous ink is printed onto offset coated, non-glossy media because the ink remains on top of the coating. Aqueous ink printing onto uncoated, porous media, however, produces washed out, poorer quality images because the inks are absorbed into the fibers of the paper. To avoid this consequence, coatings can be applied to porous media to reduce the absorption of the inks into the media. Primers, also known as precoat or pretreatment solutions, reduce the interaction of the inks with the media since the primer is interposed between the media and the inks. Because the ink image is fixed to the primer layer rather than the media, the ink image can be more easily removed. The ease of ink image removal from media is a significant factor in recycling printed media. In systems using inkjet printheads to apply primer, or precoat solutions, to print media, it is important to understand and provide mitigation interventions for missing or misdirected jets in a precoat application system.

Therefore, it is desirable to develop or design methods or systems to provide uniform placement of precoat or pretreatment solutions on print media in aqueous based ink jet printing systems and monitor these coatings or diagnose issues within the pretreatment application.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A system for detecting missing primer jets in an inkjet printer is disclosed. The system includes a media path configured to transport paper through an inkjet printer. The system also includes a print head having a plurality of primer jets configured to apply a primer solution to the paper when the paper is in proximity to the print head, an ultraviolet light source in proximity to the media path, an image sensor adjacent to the ultraviolet light source, and a controller configured to illuminate the paper with ultraviolet light from the ultraviolet light source during a detection cycle, and where the image sensor is configured to detect changes in reflectance of the paper caused by a presence or absence of primer on a surface of the paper. Implementations of the system may include a white light source, where the controller is further configured to illuminate the paper with white light from the white light source during a detection cycle, and the image sensor detects changes in reflectance of the paper caused by the presence or absence of primer on the surface of the paper when the surface of the paper may include ink. The ultraviolet light source can be positioned such that the paper passes below the print head that applies the primer solution before a print head that applies ink. The controller is configured to adjust exposure time and intensity of the light source. The exposure time and intensity of the light source are based on one or more characteristics of paper type and quality. At least one image sensor is interspersed with standard linear arrays for inline scanning. Implementations of the described techniques may include hardware, a method or process, or computer software on a computer-accessible medium.

A detection method for detecting missing primer jets in an inkjet printing system using ultraviolet (UV) illumination is disclosed. The detection method includes illuminating a paper substrate with UV light. The method also includes capturing images of the illuminated paper substrate to detect dark patches corresponding to areas where primer has been deposited and analyzing the captured images to determine whether any primer jet is missing. Implementations of the detection method may include slowing down a transport speed of the paper during inline scanning when UV uv illumination. Analyzing the captured images may include increasing process-direction DPI for primer jetted images and adjusting print speed during capturing images of the illuminated paper. The detection method may include changing a power level of the ultraviolet light while illuminating the paper substrate. The detection method may include changing an exposure time and an intensity of the ultraviolet illumination. The UV light illumination is provided with a UV light source that is external to the inkjet printing system. The UV light illumination is provided with a UV light source that is positioned along a media path in the inkjet printing system. The detection method may include illuminating the paper substrate with white light. The paper substrate may include primer. The paper substrate may include ink. Implementations of the described techniques may include hardware, a method or process, or computer software on a computer-accessible medium.

A UV illumination system for detecting missing primer jets in inkjet printing is disclosed. The UV illumination system includes at least one image sensor configured to detect changes in reflectance of paper illuminated with the ultraviolet illumination. Implementations of the UV illumination system may include a controller adapted to adjust exposure time and intensity of the light source based on one or more characteristics of paper type and quality. At least one image sensor is interspersed with standard linear arrays for inline scanning. The UV illumination system may include a light source emitting white light.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic diagram of a system and method for detecting missing primer jets in an inkjet printing system, in accordance with the present disclosure in accordance with the present disclosure.

FIG. 2A-2C are a series of schematics showing a difference in areas of a page where primer has been applied while under ultraviolet illumination, in accordance with the present disclosure.

FIG. 3 is a flowchart illustrating a detection method for detecting missing primer jets in an inkjet printing system using ultraviolet (UV) illumination, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In inkjet printers, adding a primer layer before printing ink keeps the pigment near the surface of the media, which can improve deinking, increase color gamut, and improve image quality across a wide range of substrates. Depositing the primer with an inkjet printhead can be advantageous, because it allows for flexibility in the amount deposited in different areas and on different media, and it minimizes the amount of solution used for cost and drying reasons. To maximize and maintain the benefits of primer, it is important to be able to check the health of the printhead by detecting missing jets and measuring drop placement. This leads to better decisions about when a purge/wipe maintenance cycle is required, when to turn off missing or misbehaving jets that are not fixed by maintenance, and when to enable our missing jet correction algorithm to have neighboring jets pick up the load of a missing jet. However, usual image sensors do not detect primer because it is clear and colorless. Alternative methods include the use of specialty media that reacts to the pH, water, or different types of salts in the primer, but these add cost and require a dedicated media tray.

While primer is invisible to standard inline image sensors under white light, when illuminated by UV light on papers with optical brightener (which almost all papers contain), the primer shows up as a dark patch, presumably because it blocks the UV from getting to the paper. So rather than illuminating the primer directly, the system and method of the present disclosure provides a means of illuminating the paper and inferring the placement of the primer. By using the same standard inline image sensor with UV illumination, it is possible to detect missing primer jets and use the same, or similar, missing jet detection algorithm as is used for ink to minimize their impact by increasing the number of drops printed by adjacent jets.

The UV light can be used in addition to or instead of white light LEDs. In examples, both are needed, and the UV LEDs could be interspersed in the white linear arrays, or alternatively in their own linear array adjacent to white arrays, or they could be a whole separate assembly.

When primer images are being scanned, only the UV LEDs would be illuminated, since the white LEDs would shine unwanted illumination on the darker primer areas and lower the contrast. When visible ink images are being scanned, either illumination source can be used in whatever combination gives the best results. Different illumination types may work better for different colors. For example, yellow inks can be difficult to see well in white light, so they may be more visibly apparent in UV light. Since white light LEDs are typically brighter than UV LEDs, the prints could be slowed down as necessary while they pass beneath the sensor in order to get sufficient integration time for proper sensing.

Another method for increasing the signal on a primer missing jet detection print can include printing the primer dashes or printed features at a higher dpi in the process direction. By putting more primer down per unit length, this will tend to cause more spread, widening the dashes. This can be accomplished by lengthening the dashes in the image, then printing at full frequency while the paper moves at a reduced speed. For example, a 4× longer dash printed when the paper is moving at ¼ of the speed would yield an image with a standard-length dash at 4X the ink per unit length. Alternatively, the diagnostic primer prints could be measured offline by a UV-illuminated scanner to determine which jets are missing, and that information can be fed back into the printer to make the necessary adjustments. To maximize the effect and shorten the amount of integration time required paper with more brighteners could be used.

The method described herein provides an effective way to detect missing or misdirected jets in a drop-on-demand delivery system for media priming in an inkjet printing application. By using a colorless precoat solution or primer and capturing an image of a printed pattern, it is possible to quickly and accurately identify any issues with the printer and take corrective action as needed. The precoat solution used in this method and system can be any suitable solution that helps ensure even coverage of the first predetermined pattern onto the diagnostic media or under normal printing operating conditions. In one example, the precoat solution comprises 5% wt to 40% wt of a salt in an aqueous solution based on a total weight of the aqueous solution. Additional details related to the precoat solution or primer are described in greater detail herein.

The precoat solution, also referred to as a precoat composition, precoat, primer, or primer solution, can include an aqueous salt solution that improves ink adhesion and de-inkability by “crashing” the ink pigment portion of the ink composition and preventing it from sinking or diffusing into the bulk of the paper. As used in this document, the term “primer” or “precoat” can be defined as coatings or solutions that are applied to media to improve the image quality of the ink images over that which is achieved without the coatings. The use of a salt solution as a precoat solution has several advantages, including low material cost and the ability to improve print quality on both coated and uncoated paper. The effect of “crashing,” precipitating, or causing the precipitation of a component of an ink can include any single chemical or combination of chemicals in relation to a printed ink or other printing related fluid that can facilitate the desolubilization or precipitation of one or more components in the ink. The desolubilizing can be accomplished by proton transfer from collision or close proximity of a crashing agent with one or more of the ink components. The desolubilizing can be caused by component associations induced by a combination of a precoat solution and/or component associations occurring with the precoat solution.

The mechanism by which the precoat solution crashes or causes the precipitation of the ink pigments at the surface is alternatively reasoned to be via the breaking of the surface tension of the ink which causes the pigments, dyes, or other components to precipitate and adhere to the surface of the paper. The use of a hydrophobic compliant roller system under pressure improves the application of the precoat solution by providing a uniform and consistent coating of the solution on the paper. The roller applies pressure to the solution, which helps to evenly distribute the solution, thus ensuring that the solution sufficiently covers all areas of the paper. For the purposes of this disclosure, any suitable print media, such as paper or another printable substrate, such as, but not limited to coated paper, uncoated paper, plastic films, plastic sheets, fabrics, or other printable materials can be used interchangeably. Typically, when a precoat solution, primer, ink or other material is deposited on a substrate, a first side of the substrate is commonly facing the hydrophobic compliant application member, the printheads or any other printing system component that modifies the first side or first surface of the substrate or paper. A second side may subsequently undergo a similar process, during which time it may be considered as a second side of a substrate or paper, which is a common practice when printing in duplex mode for a printing system.

Potential drawbacks or limitations of using a salt solution as a precoat solution can include the possibility of damaging the paper if too much salt is applied, or too high a content of salt is included in the salt solution, leading to the possibility of the solution being or becoming too concentrated, thus causing the ink density to increase. The precoat solution can be adjusted to improve its effectiveness on different types of paper by varying the concentration of the salt solution and the number of passes through the system. The number of passes through the system can affect the amount of salt in the precoat solution by increasing the concentration of the solution on the surface of the paper. The amount of precoat can alternatively be adjusted by deposition parameters in the print head.

Precoat solutions of the present teachings may alternatively be used with other types of inks, such as dye-based inks, but the precoat solutions may not be as effective in improving the quality of the print. The precoat solution can be compared to other pre-coating methods, such as those used in competitive products, by providing a simpler and more cost-effective solution. It also provides improved IQ metrics and de-inking capabilities.

In examples, the precoat solution and application system can be used with other types of paper surfaces, substrates, or coatings, such as UV coatings or laminates, but it may not be as effective in improving the quality of the print as when used with uncoated papers. The use and application of a precoat solution can impact the print quality and durability of the final print by improving the IQ metrics and de-inking capabilities, which can lead to a higher-quality print. The precoat solution may be used with different types of printing equipment, such as digital printers or offset presses, but it may require some modifications to the equipment to ensure that it works effectively in such equipment.

In essence, the precoat application system is configured to apply a precoat solution, disposed on at least a portion of a surface of the media, wherein a printhead delivers a quantity of precoat solution to a surface of media, in some examples, paper or other sheet or web delivered substrate, when the media is passed in proximity to a printhead configured to jet or eject a plurality of droplets of precoat solution, and the precoat solution is deposited on the surface of the paper to obtain a uniform coating of the precoat solution on the surface of the paper. In examples, of the diagnostic method described herein, the precoat may be deposited in one or more predetermined patterns. In examples, the precoat solution can include an aqueous salt solution. For example, the precoat solution can include magnesium chloride, calcium nitrate, barium, any water soluble salt of Ca²⁺, Mg²⁺, Ba²⁺, B³⁺, Al³⁺, or combinations thereof. In essence, divalent or trivalent cations are the active species included in a precoat solution. They destabilize one or more of the ink components, colloids, latex, pigments, and the like, and cause them to precipitate out of suspension or dispersion within the ink composition. A representative primer, primer solution, or precoat solution composition can be found in Table 1. All values are represented in % by weight of a total precoat solution or primer composition.

TABLE 1
Representative Precoat (Primer) Solution Composition

| | Amt | % | Suitable |
|---|---|---|---|
| | in | by | Range |
| Chemical | 1 kg | wt | (% by wt) |
| Glycerol | 21.8 | 2.2 | 0-5 |
| Propylene Glycol, | 197.7 | 19.8 | 10-40 |
| (can also include other cosolvents | | | |
| like butanediol, pentanediol, | | | |
| hexanediol, glycol ethers like | | | |
| diethylene glycol monoethyl ether, | | | |
| dipropylene glycol methyl ether, | | | |
| similar to cosolvents that may be | | | |
| present in ink formulations) | | | |
| Water | 509 | 50.9 | 30-70 |
| Magnesium Nitrate Hexahydrate | 270 | 27.0 | 10-50 |
| (can also include other metal salts | | | |
| as described herein) | | | |
| Surfactant TT4000 | 7 | 0.7 | 0.1-3 |
| Biocide Proxel | 1.45 | 0.1 | 0.1-1 |

In an example, the precoat solution comprises a magnesium chloride solution in water, where in any case, the precoat solution can include 5% wt to 40% wt of a salt in an aqueous solution based on a total weight of the aqueous solution. Other examples include from about 1% wt to about 50% wt, or from about 10% wt to about 50% wt, or from about 10% wt to about 20% wt of a salt in an aqueous solution based on a total weight of the aqueous solution.

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

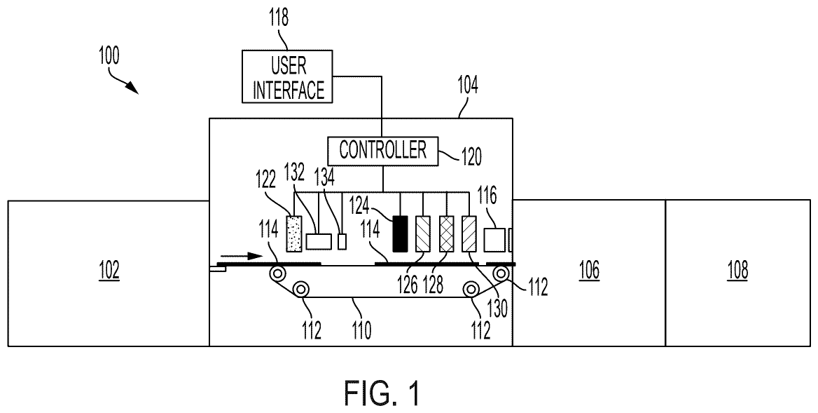

FIG. 1 is a schematic diagram of a system and method for detecting missing primer jets in an inkjet printing system, in accordance with the present disclosure. The system and a method for detecting missing primer jets can be integrated in entirety, or in part, into a high-speed color inkjet printer 100. FIG. 1 depicts a high-speed color inkjet printer 100 that uses a method in conjunction with full width printing to detect missing primer jets. As illustrated, the printer 100 directly forms an ink image on a surface of a media sheet stripped from one of the supplies of media sheets stored within a paper feeder 102 and the sheets are moved through the printer 100 in a process direction by a controller 120 operating one or more of the actuators that are operatively connected to rollers or to at least one driving roller of conveyor that comprise a portion of the media transport 110 that passes through the print engine module 104 of the printer. In one example, each printhead module has more than one printhead that form an array having a width that corresponds to a width of the widest media in the cross-process direction that can be printed by the printer.

In such examples, the printhead modules have a plurality of printheads with each printhead having a width that is less than the width of the widest media in the cross-process direction that the printer can print. In these modules, the printheads are arranged in an array of staggered printheads or a linear array of printheads that abut one another to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 100 is depicted with only two supplies of media sheets, the printer can be configured with three or more sheet supplies, each containing a different type or size of media. In exemplary printing systems, most jets on a print head are at a 1200 dpi (dots per inch) spacing. There is a region of jets on the edge of each print head with an increased jet spacing (900 dpi, then 600 dpi, then 300 dpi), such that when the two print heads are aligned properly and a left edge of one print head is printed to overlap the right edge of the neighboring print head, the 1200 dpi spacing is formed. The area of overlap is referred to as the stitch zone. In examples where one or more print heads are used to apply primer, similar printhead arrays or modules can be used to apply primer to the media or paper, similar as to how the ink is applied as described herein.

With further reference to FIG. 1, the printed image exits the print engine module 104 having a print zone of printer 100 and passes under one or more image dryers 106 after the ink image is printed on a sheet, represented herein as a more generic media 114. As used in this document, the term “print zone” means an area of a media transport opposite the printheads of an inkjet printer. The image dryer 106 can include an infrared heater, a heated air blower, air returns, or combinations of these components to heat the ink image and at least partially fix an ink image to the sheet. An infrared heater applies infrared heat to the printed image on the surface of the sheet to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer. In normal printing operations, the media 114 or sheet is jetted upon with ink or primer or precoat solution in an imagewise fashion and transported through the print zone to create a multicolor image. It should be noted that primer application is an optional feature in printing systems. The application of primer may not be integrated into all ink jet printing systems. This method of the present disclosure may not necessarily be applicable to primer or precoat application, since those fluids are generally clear or colorless and thus do not produce a measurable density. Prior to reaching the print zone, the media 114 passes beneath a primer application module 122. The primer application module 122 includes one or more printheads configured as described previously. In the implementation shown, there are four ink jetting printheads, but other systems may include more or less ink jetting printheads. These printheads are capable of ejecting drops of primer or pre-coat solution onto the media prior to the media being printed by the printhead modules 124, 126, 128, and 130. In some examples, the location and presence of primer applied to the media 114 is measured by a detector or scanner 116. It should be noted that in examples, one or more of the printhead stations, including the primer, may or may not occur in any particular sequence, depending on the stage within the diagnostic method of the present disclosure. In examples, the detector can be inline and positioned within the printing system 100 or can be external to the printer 100, such that a diagnostic sheet can be evaluated offline. The signal generated by the detector can be a visual signal, perceptible by an operator, or provided to the controller 120 via an inline scanner 116, image analysis or detector. In examples, the scanner 116 measures print density of one or more locations of the printed image. The controller 120 is configured with programmed instructions stored in non-transitory, computer readable media that when executed cause the controller to identify or capture one or more attributes related to the environmental conditions of the printer and surrounding environment, paper conditions or attributes, the amount and thickness of primer on the media and can make adjustments to the drive voltage, or other operational parameters of one or more jets or one or more print heads to correct or modify the appearance or performance or parameter of one or more settings or operating conditions to improve printing conditions or results, such as but not limited to a differential between one or more print heads in a mating edge on or between multiple print heads arranged in a print head array, or indicate a need for a manual operation or intervention by a machine operator.

In examples of a printer 100 as shown and described herein, a return path for printing duplex, or two-sided images can be employed, as well as an accompanying duplex path and controller instructions as needed. FIG. 1 also shows the printed sheets as being collected in the output module 108, but in examples, they can be directed to other processing stations (not shown) that perform tasks such as folding, collating, binding, and stapling of the media sheets.

Prior to passing through the any ink depositing print heads or print head modules 124, 126, 128, 130, the paper passes in proximity to a primer application print head 122, followed by an integrated UV illumination 132 device and an integrated image sensor 134. In other examples, the UV illumination 132 device and the image sensor 134 can be external to the printer 100. The system for detecting missing primer jets in an inkjet printer can include at least the media path or media transport 110 configured to transport paper or media 114 through an inkjet printer 100, a print head having a plurality of primer jets configured to apply a primer solution to the paper when the paper is in proximity to the print head, an ultraviolet light source in proximity to the media path, an image sensor adjacent to the ultraviolet light source, and a controller configured to illuminate the paper with ultraviolet light from the ultraviolet light source during a detection cycle, and wherein the image sensor is configured to detect changes in reflectance of the paper caused by a presence or absence of primer on a surface of the paper. In other examples, the printer 100 or system can include a white light source wherein the controller is further configured to illuminate the paper with white light from the white light source during a detection cycle, and the image sensor detects changes in reflectance of the paper caused by the presence or absence of primer on the surface of the paper when the surface of the paper comprises ink. Examples include where the ultraviolet light source is positioned such that the paper passes below the print head that applies the primer solution before a print head that applies ink and the controller is configured to adjust exposure time and intensity of the light source. The exposure time and intensity of the light source are based on one or more characteristics of paper type and quality. In other examples, at least one image sensor is interspersed with standard linear arrays for inline scanning.

Operation and control of the various subsystems, components and functions of the machine or printer 100 are performed with the aid of a controller or electronic subsystem (ESS) 120. The ESS or controller 120 is operatively connected to the components of the printhead modules 122, 124, 126, 128, and 130 (and thus the printheads), the detector, the image dryer 106, output module 108 and other system components not necessarily shown herein for purposes of clarity. The ESS or controller 120, for example, is a self-contained computer having a central processor unit (CPU) with electronic data storage, and a display or user interface (UI) 118. The ESS or controller 120, for example, includes a sensor input and control circuit as well as a pixel placement and control circuit. In addition, the controller 120 reads, captures, prepares, and manages the image data flow between image input sources, such as a scanning system or an online or a work station connection (not shown), and the printhead modules 122, 124, 126, 128, and 130. As such, the ESS or controller 120 is the main multi-tasking processor for operating and controlling all of the other machine subsystems and functions, including the printing process.

The controller 120 can be implemented with general or specialized programmable processors that execute programmed instructions. The instructions and data required to perform the programmed functions can be stored in non-transitory, computer readable medium associated with the processors or controllers. The processors, their memories, and interface circuitry configure the controllers to perform the operations described below when the programmed instructions are executed. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 120 from either a scanning system or an online or work station connection for processing and generation of the printhead control signals output to the printhead modules 122, 124, 126, 128, and 130. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

The inline scanner 116 can capture an image of the top surface of the print media, allowing for the detection of any missing jets, print density, or other defects in the printing system. Any scanner that can capture high-resolution images of the print media surface can be used for this purpose. The dryer is used for drying solid patches of ink on the first surface of the print media, including methods for drying the ink droplets using heat or UV light to evaporate the solvent in the ink.

The use of an inline scanner, either 134 or 116 enables capture of an image of the top surface of the print media as it passes through the printer. The scanner can analyze for and detect any missing jets or defects in the printing system, including the print head depositing primer. By comparing a target print image density with the actual measurement results and evaluating criteria such as uniformity, coverage, and defects, the inline scanner helps identify areas where adjustments to print head jetting conditions can be improved.

The present disclosure provides for using ultraviolet (UV) illumination in combination with an image sensor and existing algorithms used by various printers to detect missing jet primers during the printing process. This approach leverages the properties of optical brighteners found in most paper substrates, which absorb or scatter UV light when excited, causing primer areas under UV illumination to appear darker than surrounding clear media regions. To enable this detection method, a standard inline image sensor may be modified with software adjustments for optimal performance using UVA wavelengths between 360-400 nanometers.

In one example, the existing white LED arrays used in inkjet printers can be replaced or supplemented by dedicated UV LEDs arranged alongside them to provide simultaneous illumination of both visible ink and primer areas. This combination allows for seamless switching between detecting missing jets during printing with either UV light alone or a blend of UVA and white light sources. In another example, the inline image sensor is designed specifically for use in conjunction with high-intensity UV lamps (e.g., 300 W) to enhance primer visibility by increasing exposure times. This approach may be useful when dealing with paper substrates having lower optical brightener concentrations or those that require more intense illumination due to their inherent properties. In yet another example, the inline image sensor can be integrated into a separate assembly from white LEDs and UV LEDs for greater flexibility in configuring different lighting scenarios depending on specific application requirements. This modular design enables easy adaptation of existing printer designs without hardware modifications by simply swapping out or adjusting LED configurations as needed.

The primer detection algorithm employed in this system and method leverages a modified version of the existing ink detection software used by Xerox printers to detect missing jets and measure drop placement accuracy (Xdp) and Y-axis deviation (Ydp). This adaptation involves adjusting specific parameters, such as threshold values for signal processing, noise filtering techniques, and image segmentation algorithms. The primer-specific algorithm is configured to account for differences in UV illumination's absorption patterns by primers versus white light transmission through clear media. To accommodate different printhead designs or environmental conditions affecting print quality, the algorithm may need adjustments in parameters such as sensitivity levels, spatial resolution, or processing speed.

In offline scanning configurations, the algorithm may be optimized for specific paper types or color profiles by incorporating additional data from spectrophotometers or other quality control devices integrated into the system. This enables real-time monitoring of print quality parameters such as dot placement accuracy (Xdp) and Y-axis deviation (Ydp), allowing for more precise adjustments to printing conditions.

The addition of white light LEDs to the system as described herein provides useful flexibility and adaptability when detecting primer missing jets. In one example, the white LEDs are interspersed among the existing linear array used for visible ink detection, allowing seamless switching between different illumination modes without requiring useful hardware modifications. This configuration enables real-time monitoring of both UV-absorbing primers and visible inks on a single inline image sensor. Another useful approach involves using separate arrays or modules specifically configured to accommodate white LEDs alongside dedicated UV LED assemblies. In this example, the system may be configured for optimal performance based on specific application requirements, such as color-specific detection or paper type handling.

In another alternative configuration, the white light source is used in combination with a high-intensity UV lamp (e.g., 300 W for approximately 1 second to about 30 seconds) to enhance primer visibility and improve signal-to-noise ratios. This approach may involve adjusting LED spacing, control algorithms, or exposure times depending on specific requirements for optimal performance. In other examples, infrared illumination could be used in combination with either visible (i.e., white light or blue light) or ultraviolet illumination. In still other examples deep UV illumination or other subsets of UV illumination can be used. For instance, when detecting yellow ink patterns under white light illumination, the system may be replaced or optimized by using a higher-intensity UV lamp (e.g., 400 W) to compensate for reduced contrast of yellow that is visible under white or visible light illumination.

In yet another example, separate linear arrays of white LEDs are used in conjunction with dedicated UV LED assemblies. This configuration allows for independent control over each lighting source and enables real-time monitoring of both primer patterns under UV illumination as well as visible ink detection using the standard inline image sensor. The system may be further optimized by adjusting exposure times or integration periods based on specific application requirements, such as higher-end graphics printing.

A UV-illuminated scanner may be used offline to detect missing jets and feed back into the printer for correction purposes. This example offers a useful alternative or complementary approach to inline scanning with combination light sources. The separate scanner would utilize ultraviolet (UV) illumination, which interacts with optical brighteners present in paper substrates, causing them to absorb certain wavelengths and appear darker under UV exposure.

To enhance primer visibility and improve missing jet detection accuracy, it may be useful to increase the amount of optical brighteners in certain papers or media used with this technology. This may be achieved through various examples that involve adding a higher concentration of fluorescent whitening agents (FWAs) during paper manufacturing processes. For instance, one example involves incorporating FWAs into the pulp mixture before forming sheets for printing applications. Another approach is to apply an FWA coating onto existing papers or media using techniques such as spraying, padding, or calendaring. This paper could be used as a diagnostic print media substrate, yet not in common printing operations within the printing system.

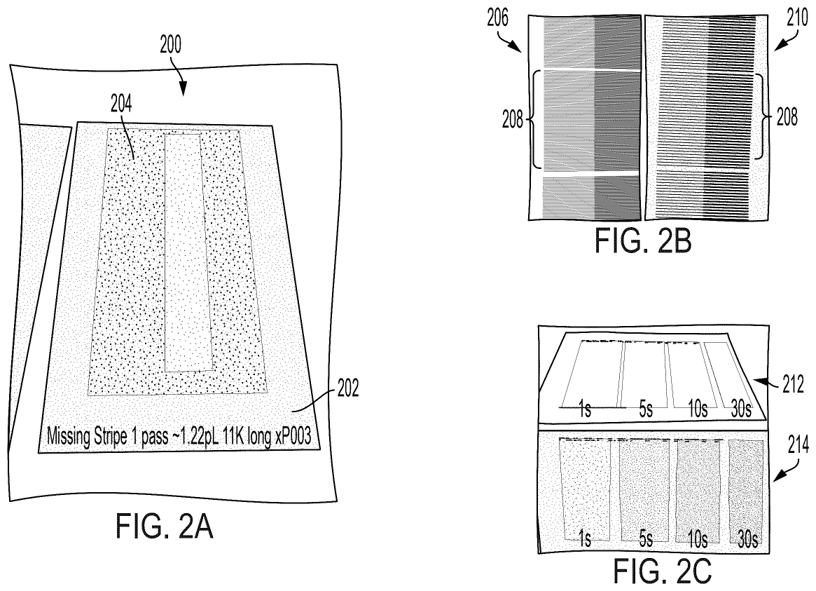

FIG. 2A-2C are a series of schematics showing a difference in areas of a page where primer has been applied while under ultraviolet illumination, in accordance with the present disclosure. FIG. 2A shows a test result 200 with a page of media 202 illuminated under UV radiation or illumination, where a section of the page of media 202 has been applied with primer 204. Illumination with an inexpensive UV flashlight demonstrated that it is possible to observe the primer with sufficient resolution for at least detecting missing jets. In examples, the use of higher intensity or longer exposure of ultraviolet illumination can enable the use of the present teachings for measuring the accuracy of dot position (Xdp and Ydp) as well as for missing jets.

FIG. 2B shows a schematic of an image evaluating 4-color diagnostic patterns 208 on a page without UV light 206 and with UV light 210 which demonstrated that yellow has more contrast under UV illumination than it does under white light. Since it is generally more difficult to visually observe yellow, blue light has been used previously, but the UV light showed higher visible contrast than blue or white light. In examples, white light is not one wavelength, it is composed of a combination of other colors from roughly 400 to about 700 nm. White light can include all the intermediate wavelengths continuously, or it can be the sum of three or more discrete colors in widely-separated parts of that range (such as, for example, RGB). Blue light can be considered to be in the range of from about 400 nm to about 500 nm, but a tighter range used can be from about 450 nm to about 495 nm. In other examples, cyan, magenta, and black patterns appear about the same contrast under UV illumination as with white light. As shown in FIG. 2C, in still other examples, such as for cases where the primer was more difficult to visually observe 212, exposure to a 300 W UV lamp for 1 second to about 30 seconds caused the primer image 214 to be darker and thus easier to measure. This result was also proven to be repeatable.

In some examples, it may become useful to adjust exposure times or lamp intensity based on real-time monitoring of substrate quality and environmental conditions during printing. This approach ensures optimal primer image enhancement during detection for missing or plugged jets while minimizing potential risks associated with excessive UV radiation damage to certain papers. By incorporating this technique into the existing inline scanning process, the enhanced visibility of primer images also enables more accurate detection and correction of issues related to clogged nozzles, misaligned printheads, paper jams, or environmental fluctuations.

Inline scanning with combination light sources offers a versatile and useful approach to detecting primer missing jets in inkjet printers. In one example, UV LEDs are interspersed within white linear arrays of an inline image sensor, allowing for seamless switching between visible ink detection and primer monitoring during printing cycles. This configuration enables the printer to adaptively adjust its operation based on real-time feedback from both types of illumination sources.

Another approach involves using a separate array dedicated solely to UV LEDs, which may be positioned adjacent or in parallel with white linear arrays depending on specific application requirements. In this example, software controls can be used to toggle between different light source configurations for optimal performance and color accuracy. For instance, when detecting yellow ink patterns, the printer may switch from visible illumination to UV lighting to improve contrast.

In yet another implementation, a combination of UV LEDs with distinct spectral profiles is employed in conjunction with white linear arrays. This allows printers to fine-tune their detection algorithms for specific paper types or color gamuts by adjusting LED intensities and exposure times accordingly. For instance, when printing on high-brightness papers, the printer may increase UV illumination intensity while reducing visible light levels to maintain optimal primer visibility. In examples, two common UV LED wavelengths are 365 nm and 395 nm, each having significant output at +/−10 nm of the center wavelength.

In another example, the printer can incorporate a UV-illuminated scanner as an independent device for offline primer monitoring, allowing users to inspect print quality without interrupting production cycles. When using combination light sources, it can be helpful to consider factors such as LED spacing, control algorithms, and paper handling requirements. For instance, in some examples, printers may employ specialized paper trays or substrate holders designed specifically for UV-illuminated scanning.

In a further example, adaptive algorithms can be employed to dynamically adjust illumination patterns based on real-time feedback from sensor data. By analyzing primer density, paper type, ink color, and other factors, these software controls may optimize UV LED intensity, exposure time, and spatial distribution for optimal detection accuracy in various printing scenarios. In some examples, the dedicated array(s) for UV illumination may be designed with adjustable intensity levels or pulse-width modulation (PWM), enabling fine-tuned control over primer detection and minimizing potential interference from ambient light sources. Additionally, these separate arrays may incorporate specialized LED packages optimized for UVA emission spectra to maximize sensitivity in detecting subtle changes within paper substrates.

To effectively detect missing jets in a printing process using primer detection methods and systems described herein, it can be useful to choose an illumination source that optimizes the visibility of various ink colors on paper substrates. One example involves interspersing ultraviolet LEDs with standard linear arrays of white LEDS within the inline image sensor for seamless switching between visible ink detection and primer monitoring within printing operations. Such a configuration allows for real-time adjustments based on specific print head characteristics, or image content, or paper qualities.

Another useful approach is to use a combination UV-LED array with adjustable intensity levels. For example, in one example, the UV LEDs may be adjusted to emit light within the range of 360-400 nanometers (UVA spectrum) for optimal primer detection on paper substrates containing optical brighteners. In contrast, white LED arrays emitting at around 5500K color temperature and a spectral power distribution tailored towards visible ink colors like yellow may provide better visibility.

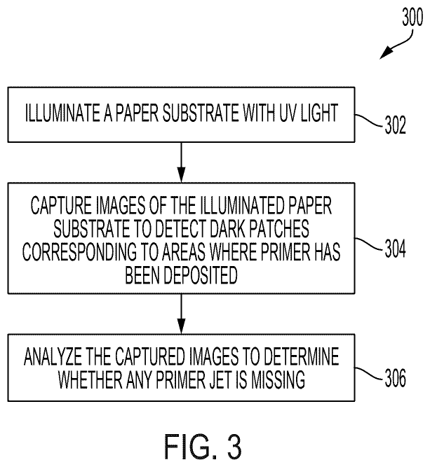

FIG. 3 is a flowchart illustrating a detection method for detecting missing primer jets in an inkjet printing system using ultraviolet (UV) illumination, in accordance with the present disclosure. A detection method 300 for detecting missing primer jets in an inkjet printing system using ultraviolet (UV) illumination includes illuminating a paper substrate with UV light 302, capturing images of the illuminated paper substrate to detect dark patches corresponding to areas where primer has been deposited 304, and analyzing the captured images to determine whether any primer jet is missing 306. In examples, the method 300 further includes slowing down a transport speed of the paper during inline scanning when using UV illumination. In other examples, the detection method 300 include where the analyzing step comprises increasing process-direction DPI for primer jetted images and adjusting print speed during capturing images of the illuminated paper. The method 300 can also include changing the power level or wattage of the ultraviolet light while illuminating the paper substrate, or changing the exposure time and intensity of the ultraviolet light illumination. In certain examples, the UV light illumination used in the method 300 is provided with a UV light source that is external to the inkjet printing system. Alternatively, the UV light illumination is provided with a UV light source that is positioned along a media path in the inkjet printing system. The method 300 can include illuminating the paper substrate with white light, as described previously. The paper substrate can include primer, or ink, or both during the detection method of the present disclosure. As such, the test images can be evaluated with the presence of ink or in the absence of ink on the paper with an initial primer deposition. In examples, the system configuration and method can be practiced using an external light source and image scanner, an internal light source and image scanner, or a combination thereof. The method can also include adjusting the primer application print head to improve primer deposition or accommodate the occurrence of a missing or plugged or misdirected jet in the primer application print head. In some examples, changing the exposure time of the ultraviolet light can be accomplished by changing the speed of the media path. Alternatively, the system can be directed to print longer primer features, such as test features that are dimensionally larger in the process direction to change the size of the primer feature on a surface of the paper and therefore improve detectability.

Aspects of the present disclosure can include the detection of primer using UV light, while in examples using paper with higher amounts of brightener for improved signal. Under UV illumination, the system and method could make the primer image darker by exposure to a higher-power UV lamp to use UV light to perform missing jet correction on prints. The present disclosure provides the use of both inline and offline scanning, slowing down paper for inline scanning, or increasing the process-direction DPI to improve the signal. In other examples, the system and method of the present disclosure provides using UV light when scanning certain colors of visible ink (for example, yellow). In examples, the use of an inline scanner with combination UV and white light sources, UV illumination interspersed with white LEDs or as a separate array and the choosing of an optimal combination of UV and white light can be used for detecting different ink colors.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A system for detecting missing primer jets in an inkjet printer, the system comprising:
a media path configured to transport paper through an inkjet printer;
a print head having a plurality of primer jets configured to apply a primer solution to the paper when the paper is in proximity to the print head;
an ultraviolet light source in proximity to the media path;
an image sensor adjacent to the ultraviolet light source; and
a controller configured to illuminate the paper with ultraviolet light from the ultraviolet light source during a detection cycle; and wherein:
the image sensor is configured to detect changes in reflectance of the paper caused by a presence or absence of primer on a surface of the paper.

2. The system according to claim 1, further comprising a white light source; and wherein:
the controller is further configured to illuminate the paper with white light from the white light source during a detection cycle; and
the image sensor detects changes in reflectance of the paper caused by the presence or absence of primer on the surface of the paper when the surface of the paper comprises ink.

3. The system according to claim 1, wherein the ultraviolet light source is positioned such that the paper passes below the print head that applies the primer solution before a print head that applies ink.

4. The system according to claim 1, wherein the controller is configured to adjust exposure time and intensity of the light source.

5. The system according to claim 4, wherein the exposure time and intensity of the light source are based on one or more characteristics of paper type and quality.

6. The system according to claim 1, wherein at least one image sensor is interspersed with standard linear arrays for inline scanning.

7. A detection method for detecting missing primer jets in an inkjet printing system using ultraviolet (UV) illumination, the method comprising:
illuminating a paper substrate with UV light;
capturing images of the illuminated paper substrate to detect dark patches corresponding to areas where primer has been deposited; and
analyzing the captured images to determine whether any primer jet is missing.

8. The detection method according to claim 7, further comprising slowing down a transport speed of the paper during inline scanning when using UV illumination.

9. The detection method according to claim 7, wherein analyzing the captured images comprises increasing process-direction DPI for primer jetted images and adjusting print speed during capturing images of the illuminated paper.

10. The detection method according to claim 7, further comprising changing a power level of the ultraviolet light while illuminating the paper substrate.

11. The detection method according to claim 7, further comprising changing an exposure time and an intensity of the ultraviolet illumination.

12. The detection method according to claim 7, wherein the UV light illumination is provided with a UV light source that is external to the inkjet printing system.

13. The detection method according to claim 7, wherein the UV light illumination is provided with a UV light source that is positioned along a media path in the inkjet printing system.

14. The detection method according to claim 7, further comprising illuminating the paper substrate with white light.

15. The detection method according to claim 7, wherein the paper substrate comprises primer.

16. The detection method according to claim 7, wherein the paper substrate comprises ink.

17. A UV illumination system for detecting missing primer jets in inkjet printing, the system comprising:
a light source emitting ultraviolet illumination; and
at least one image sensor configured to detect changes in reflectance of paper illuminated with the ultraviolet illumination.

18. The UV illumination system according to claim 17, further comprising a controller adapted to adjust exposure time and intensity of the light source based on one or more characteristics of paper type and quality.

19. The UV illumination system according to claim 17, wherein at least one image sensor is interspersed with standard linear arrays for inline scanning.

20. The UV illumination system according to claim 17, further comprising a light source emitting white light.
